(19) United States
(12) Patent Application Publication
(10) Pub. No.: US 2009/0003186 A1
(43) Pub. Date: Jan. 1, 2009

(54) Probe, Recording Apparatus, Reproducing Apparatus, And Recording/Reproducing Apparatus

(76) Inventor: Hirokazu Takahashi, Saitama (JP)

Correspondence Address: NIXON & VANDERHYE, PC, 901 NORTH GLEBE ROAD, 11TH FLOOR, ARLINGTON, VA, 22203, US

(21) Appl. No.: 11/661,222

(22) PCT Filed: Aug. 26, 2005
(86) PCT No.: PCT/JP2005/015577

§ 371 Date: Feb. 26, 2007

(30) Foreign Application Priority Data
Aug. 27, 2004 (JP) 2004-248557

(51) Int. Cl. G11B 9/02

(52) U.S. Cl. 369/126; G9B/9.012

(57) ABSTRACT

A probe (100) is provided with: a head portion (130) including a projection (110) with its tip facing a medium (20); a return electrode (150) for returning thereto an electric field applied from the projection; a first wire (120a) extending in predetermined one direction so as to be connected to the projection; and a second wire (120b) extending in another direction different from the one direction so as to be connected to said return electrode.

### TECHNICAL FIELD

The present invention relates to a probe for recording and reproducing polarization information recorded in a dielectric substance, such as a ferroelectric recording medium, and a recording apparatus, a reproducing apparatus, and a recording/reproducing apparatus which use the probe, for example.

### BACKGROUND ART

The inventor of the present invention and others have proposed a technology of a recording/reproducing apparatus using SNDM (Scanning Nonlinear Dielectric Microscopy) for nanoscale analysis of a dielectric recording medium. In the SNDM, by using an electrically conductive cantilever (or probe) having a small projection on its tip, which is used for atomic force microscopy (AFM) or the like, the resolution of measurement can be increased to sub-nanometer. Recently, by applying the technology of SNDM, a super high-density recording/reproducing apparatus has been developed, wherein the apparatus records data into a recording medium having a recording layer made of a ferroelectric material (refer to a patent document 1).

On the recording/reproducing apparatus using such SNDM, the information is reproduced by detecting the positive/negative direction of polarization of the recording medium. This is performed by using the fact that the oscillation frequency of a LC oscillator, which includes a high-frequency feedback amplifier including a L component, the electrically conductive probe mounted on the amplifier, and the capacitance Cs of a ferroelectric material under the probe, is changed by a change A C in small capacitance, which is caused by the extent of a non-linear dielectric constant due to the distribution of the positive/negative polarization. Namely, this is performed by detecting a change in the distribution of the positive/negative polarization, as a change in oscillation frequency Δf.

Moreover, in order to detect the difference in the positive/negative polarization, an alternating electric field having sufficiently low frequency with respect to the oscillation frequency is applied, to thereby change the oscillation frequency with the alternating electric field. At the same time, a ratio of the change in the oscillation frequency, including a code or sign, is determined from the non-linear dielectric constant of the ferroelectric material under the probe. Moreover, by extracting a component caused by the alternating electric field by using the FM (Frequency Modulation)-demodulation, from a high-frequency signal of the LC oscillator, which is FM-modulated in accordance with the change A C in the small capacitance associated with the application of the alternating electric field, the record information recorded in the ferroelectric recording medium is reproduced.

Patent document 1: Japanese Patent Application Laying Open NO. 2003-085969

### DISCLOSURE OF INVENTION

### Subject to be Solved by the Invention

In order to properly detect the change ΔC in the small capacitance of the dielectric material, the probe is provided, in its vicinity, with a return electrode for returning thereto the alternating electric field applied from the probe. However, since the probe is typically small, a wire connected to the probe and a wire connected to the return electrode are forced to come close to each other. Having such a wiring structure causes the generation of a floating capacitance between the wires, and thus there is a technical problem of generation of crosstalk. As a result, there is such a technical problem that due to the floating capacitance, the change ΔC in the small capacitance associated with the application of the alternating electric field cannot be detected, highly accurately.

In order to solve the above-mentioned problems, it is therefore an object of the present invention to provide a probe which can reduce the generation of the floating capacitance, and a recording apparatus, a reproducing apparatus, and a recording/reproducing apparatus which use the probe.

### Means for Solving the Object

(Probe)

The above object of the present invention can be achieved by a first probe provided with: a head portion including a projection with its tip facing a medium; a return electrode for returning thereto an electric field applied from the projection; a first wire extending in predetermined one direction so as to be connected to the projection; and a second wire extending in another direction different from the one direction so as to be connected to the return electrode.

According to the first probe of the present invention, the electric field applied from the projection returns to the return electrode, by which a change in the dielectric constant on the recording surface of, for example, a dielectric recording medium, which is one specific example of the medium, can be detected as a change in capacitance. Namely, it is possible to preferably reproduce information recorded in the dielectric recording medium. Moreover, by applying the electric field from the projection to the dielectric recording medium, it is possible to preferably record information into the dielectric recording medium.

Moreover, the first probe is provided with the first wire connected to (i.e. to provide electrical continuity with) the projection and the second wire connected to the return electrode. Here, the expression “connected” in the present invention, in effect, includes a wide concept, not only indicating a case where the first wire and the projection, or the second wire and the return electrode, are directly (i.e. physically) connected, but also indicating a case where they are indirectly connected. Namely, if the first wire and the projection, or the second wire and the return electrode, can provide the electrical continuity for each other, that corresponds to the “connected” condition of the present invention. For example, if an electric current supplied to the first wire passes through one portion of the head portion and flows to the projection, even if the first wire and the projection are not directly connected, the first wire and the projection are connected in view point of the above-mentioned wide concept.

In the first probe, particularly, the directions that the first wire and the second wire extend are different from each other. Namely, the first wire extends in one direction, whereas the second wire extends in another direction different from the one direction. In other words, the first wire and the second wire do not extend side by side. Therefore, a floating capacitance that can be generated between the first wire and the second wire can be reduced, or the generation thereof can be inhibited or prevented. As a result, an influence of a noise or the like, caused by the floating capacitance, can be eliminated, and, for example, the dielectric constant of the dielectric recording medium (specifically, a dielectric material) can be detected as the change in capacitance (particularly, small capacitance) of the dielectric recording medium, with high accuracy and in high quality. Namely, it is possible to improve information reproduction quality, especially. Alternatively, regardless of the dielectric recording medium, if the head portion is displaced on the medium surface, the influence of the noise caused by the floating capacitance can be eliminated, to thereby detect various information, highly accurately.

Moreover, even in the recording operation, an electric field without the noise or the like caused by the floating capacitance can be preferably applied to the medium from the projection, so that it is also possible to record the information in higher quality.

Consequently, according to the first probe of the present invention, since the first wire and the second wire extend in different directions from each other, the distance between the first wire and the second wire becomes long. Thus, the floating capacitance can be reduced, or the generation thereof can be inhibited or prevented. As a result, it is possible to preferably perform the information recording, reproduction, detection, or the like.

In one aspect of the first probe of the present invention, the one direction and the another direction have an angle difference of at least 90 degrees or more.

According to this aspect, the floating capacitance can be effectively reduced, or the generation thereof can be effectively inhibited or prevented. In other words, if the angle formed by the first wire and the second wire is not acute, the above-mentioned benefits can be received.

In another aspect of the first probe of the present invention, the one direction and the another direction are opposite.

According to this aspect, the floating capacitance can be reduced, or the generation thereof can be inhibited or prevented, more effectively.

In another aspect of the first probe of the present invention, each of the first wire and the second wire extends on the same plane.

According to this aspect, the height of the probe can be relatively reduced. In other words, the probe can be relatively thinned. By this, it is possible to use the smaller probe.

The above object of the present invention can be also achieved by a second probe provided with: a head portion including a projection with its tip facing a medium; a return electrode for returning thereto an electric field applied from the projection; a first wire extending on predetermined one plane so as to be connected to the projection; and a second wire extending on another plane at a different height from that of the one plane so as to be connected to the return electrode.

According to the second probe of the present invention, as in the first probe of the present invention, for example, it is possible to record information into the dielectric recording medium and reproduce the information recorded in the dielectric recording medium.

Particularly in the second probe, the one plane on which the first wire extends and the another plane on which the second wire extends have different heights from each other. Specifically, when a probe according to the second probe is actually used for a dielectric recording/reproducing apparatus described later, the first wire and the second wire extend at different heights, respectively.

Incidentally, the “one plane” and the “another plane” may be a single plane, or a plurality of planes. For example, the first wire may be extended without changing the height (i.e. on the single plane), or with changing the height. Moreover, the second wire may be extended without changing the height, or with changing the height. The point is that it is only necessary to provide the probe in which the first wire and the second wire do not extend side by side on the plane at the same height.

By this, the distance between the first wire and the second wire becomes long. Thus, the floating capacitance can be reduced, or the generation thereof can be inhibited or prevented. As a result, it is possible to preferably perform the information recording, reproduction, detection, or the like.

In one aspect of the second probe of the present invention, each of the first wire and the second wire extends in the same direction.

According to this aspect, the wide or length of the probe can be relatively reduced. Namely, it is possible to use the smaller probe.

In another aspect of the first or second probe of the present invention, it is further provided with a top board for supporting at least one of the first wire and the second wire.

According to this aspect, using the top board, the first wire and the second wire can be supported. For example, if the first wire and the second wire are formed on the top board, it is possible to vary the directions in which the first wire and the second wire extend, or vary the heights at which the first wire and the second wire are formed, relatively easily, by arbitrarily changing the shape of the top board, as described above.

In the first or second probe of the present invention, the projection and the return electrode are adjacent to each other.

According to this aspect, by displacing the projection and the return electrode adjacent to each other, a feedback route of an oscillation circuit described later (specifically, the route of the electric field applied from the projection returning to the return electrode) can be shorten. As a result, it is possible to effectively prevent the noise (e.g. a floating capacitance component) from entering into the oscillation circuit. Even if the projection and the return electrode are set to be adjacent to each other, the first or second probe can reduce the floating capacitance or inhibit or prevent the generation thereof. Thus, there is such an advantage that the technical problem caused by the floating capacitance hardly occur or does not occur at all.

In the first or second probe of the present invention, the head portion includes diamond to which impurities are doped.

According to this aspect, super hard and lubricant diamond can be used as the head portion including the projection. Since it has stronger resistance to deterioration and electrical conductivity, the resistance value as the probe can be kept low. Incidentally, in this aspect, the impurities to be doped may be, for example, boron, or impurities associated to other atoms or the like if capable of providing electrical conductivity for diamond.

In another aspect of the first or second probe of the present invention, a foundation layer whose adherence is stronger than that of at least one of the first and second wires is formed, at least one of the first and second wires being formed on the foundation layer.

According to this aspect, it is possible to further prevent the exfoliation of the first and the second wires.

The above object of the present invention can be also achieved by a third probe provided with: a head portion including a plurality of projections with each of their tips facing a medium; at least one return electrode for returning thereto an electric field applied from at least one of the plurality of projections; a plurality of first wires extending in different directions from each other so as to be connected to the respective projections; and a second wire extending in a different direction from the directions in which the plurality of first wires extend so as to be connected to the at least one return electrode.

According to the third probe of the present invention, the plurality of first wires connected to the respective projections and the second wire connected to the return electrode extend in different directions from each other. Thus, as in the above-mentioned first or second probe, the floating capacitance can be reduced, or the generation thereof can be inhibited or prevented. In particular, even in case of the probe in which the increase in the number of the wires facilitates the generation of the floating capacitance, the floating capacitance can be reduced, or the generation thereof can be inhibited or prevented, effectively, by employing the structure as in the first probe.

Incidentally, in response to the various aspects of the first probe of the present invention described above, the third probe of the present invention can also adopt various aspects.

The above object of the present invention can be also achieved by a fourth probe provided with: a head portion including a plurality of projections with each of their tips facing a medium; at least one return electrode for returning thereto an electric field applied from at least one of the plurality of projections; a plurality of first wires extending on different planes so as to be connected to the respective projections; and a second wire extending on a plane at a different height from those of the planes in which the plurality of first wires extend so as to be connected to the at least one return electrode.

According to the fourth probe of the present invention, the plurality of first wires connected to the respective projections and the second wire connected to the return electrode extend on different planes from each other. Thus, as in the above-mentioned first or second probe, the floating capacitance can be reduced, or the generation thereof can be inhibited or prevented. In particular, even in case of the probe in which the increase in the number of the wires facilitates the generation of the floating capacitance, the floating capacitance can be reduced, or the generation thereof can be inhibited or prevented, effectively, by employing the structure as in the first probe.

Incidentally, in response to the various aspects of the second probe of the present invention described above, the fourth probe of the present invention can also adopt various aspects.

(Recording Apparatus)

The above object of the present invention can be also achieved by a recording apparatus for recording data into a dielectric recording medium, the recording apparatus provided with: the above-mentioned probe of the present invention (including its various aspects); and a record signal generating device for generating a record signal corresponding to the data.

According to the recording apparatus of the present invention, while taking advantage of the above-mentioned probe of the present invention, data can be recorded on the basis of the record signal generated by the record signal generating device.

Incidentally, in response to the first, second, third, or fourth probe of the present invention described above, the recording device of the present invention can adopt various aspects.

(Reproducing Apparatus)

The above object of the present invention can be also achieved by a reproducing apparatus for reproducing data recorded in a dielectric recording medium, the reproducing apparatus provided with: the above-mentioned probe of the present invention (including its various aspects); an electric field applying device for applying an electric field to the dielectric recording medium; an oscillating device whose oscillation frequency varies depending on a difference in capacitance corresponding to a nonlinear dielectric constant of the dielectric recording medium; and a reproducing device for demodulating an oscillation signal generated by the oscillating device and reproducing the data.

According to the reproducing apparatus of the present invention, the electric field is applied by the electric field applying device to the dielectric recording medium. By this, the capacitance is changed depending on a change in the nonlinear dielectric constant of the dielectric recording medium. Due to the capacitance change, the oscillation frequency of the oscillating device is changed. Then, the oscillation signal corresponding to the change in the oscillation frequency by the oscillating device is demodulated and reproduced by the reproducing device, to thereby reproduce the data.

Particularly in the present invention, the data can be reproduced with taking advantage of the probe of the present invention described above.

Incidentally, in response to the first, second, third, or fourth probe of the present invention described above, the reproducing device of the present invention can adopt various aspects.

(Recording/Reproducing Apparatus)

The above object of the present invention can be also achieved by a recording/reproducing apparatus for recording data into a dielectric recording medium and reproducing the data recorded in the dielectric recording medium, the recording/reproducing apparatus provided with: the above-mentioned probe of the present invention (including its various aspects); a record signal generating device for generating a record signal corresponding to the data; an electric field applying device for applying an electric field to the dielectric recording medium; an oscillating device whose oscillation frequency varies depending on a difference in capacitance corresponding to a nonlinear dielectric constant of the dielectric recording medium; and a reproducing device for demodulating an oscillation signal generated by the oscillating device and reproducing the data.

According to the recording/reproducing apparatus of the present invention, as in the above-mentioned recording apparatus or reproducing apparatus, the data can be recorded or reproduced with taking advantage of the probe of the present invention described above.

Incidentally, in response to the first, second, third, or fourth probe of the present invention described above, the recording/reproducing device of the present invention can adopt various aspects.

These effects and other advantages of the present invention will become more apparent from the following embodiments.

As explained above, according to the first or third probe of the present invention, it is provided with the head portion, the return electrode, the first wire, and the second wire, and the directions in which the first wire and the second wire extend are different from each other. Moreover, according to the second or fourth probe of the present invention, it is provided with the head portion, the return electrode, the first wire, and the second wire, and the heights at which the first wire and the second wire are formed are different from each other. Therefore, the floating capacitance which can be generated between the first wire and the second wire can be reduced, or the generation thereof can be inhibited or prevented.

Moreover, according to the recording apparatus of the present invention, it is provided with the probe and the record signal generating device. Therefore, it is possible to receive the various benefits of the probe of the present invention.

Moreover, according to the reproducing apparatus of the present invention, it is provided with the probe, the electric field applying device, the oscillating device, and the reproducing device. Therefore, it is possible to receive the various benefits of the probe of the present invention. As a result, it is possible to reproduce the data more stably.

### BRIEF DESCRIPTION OF DRAWINGS

FIG. 1 are a side view and a plan view conceptually showing one specific example of an embodiment of a recording/reproducing head.

FIG. 2 is a plan view conceptually showing another specific example of the embodiment of the recording/reproducing head.

FIG. 3 is a plan view conceptually showing another specific example of the embodiment of the recording/reproducing head.

FIG. 4 is a plan view conceptually showing a specific example of a recording/reproducing head in a comparison example.

FIG. 5 is a cross sectional view conceptually showing one process of the manufacturing method of the embodiment of the recording/reproducing head.

FIG. 6 is a cross sectional view conceptually showing another process of the manufacturing method of the embodiment of the recording/reproducing head.

FIG. 7 are a cross sectional view and a plan view conceptually showing another process of the manufacturing method of the embodiment of the recording/reproducing head.

FIG. 8 are a cross sectional view and a plan view conceptually showing another process of the manufacturing method of the embodiment of the recording/reproducing head.

FIG. 9 are a cross sectional view and a plan view conceptually showing another process of the manufacturing method of the embodiment of the recording/reproducing head.

FIG. 10 are a cross sectional view and a plan view conceptually showing another process of the manufacturing method of the embodiment of the recording/reproducing head.

FIG. 11 are a cross sectional view and a plan view conceptually showing another process of the manufacturing method of the embodiment of the recording/reproducing head.

FIG. 12 is a cross sectional view conceptually showing another process of the manufacturing method of the embodiment of the recording/reproducing head.

FIG. 13 is a cross sectional view conceptually showing another process of the manufacturing method of the embodiment of the recording/reproducing head.

FIG. 14 is a cross sectional view conceptually showing another process of the manufacturing method of the embodiment of the recording/reproducing head.

FIG. 15 is a cross sectional view conceptually showing another process of the manufacturing method of the embodiment of the recording/reproducing head.

FIG. 16 is a cross sectional view conceptually showing another process of the manufacturing method of the embodiment of the recording/reproducing head.

FIG. 17 are a cross sectional view and a plan view conceptually showing another process of the manufacturing method of the embodiment of the recording/reproducing head.

FIG. 18 are a cross sectional view and a plan view conceptually showing another process of the manufacturing method of the embodiment of the recording/reproducing head.

FIG. 19 is a cross sectional view and a plan view conceptually showing another process of the manufacturing method of the embodiment of the recording/reproducing head.

FIG. 20 are a cross sectional view and a plan view conceptually showing another process of the manufacturing method of the embodiment of the recording/reproducing head.

FIG. 21 is a cross sectional view conceptually showing another process of the manufacturing method of the embodiment of the recording/reproducing head.

FIG. 22 are a side view and a front view conceptually showing another embodiment of the recording/reproducing head.

FIG. 23 is a side view and a plan view conceptually showing one embodiment of a recording/reproducing head array.

FIG. 24 is a side view and a front view conceptually showing another embodiment of the recording/reproducing head array.

FIG. 25 is a block diagram conceptually showing the basic structure of an embodiment of a dielectric recording/reproducing apparatus which employs the embodiment of the recording/reproducing head.

FIG. 26 are a plan view and a cross sectional view conceptually showing a dielectric recording medium used for the reproduction of the dielectric recording/reproducing apparatus in the embodiment.

FIG. 27 is a cross sectional view conceptually showing the recording operation of the dielectric recording/reproducing apparatus in the embodiment.

FIG. 28 is a cross sectional view conceptually showing the reproduction operation of the dielectric recording/reproducing apparatus in the embodiment.

### DESCRIPTION OF REFERENCE CODES

1 dielectric recording/reproducing apparatus
13 oscillator
14 resonance circuit
16 electrode
17 dielectric material
20 dielectric recording medium
21 alternating current signal generator
22 record signal generator
100 recording/reproducing head
110 diamond tip
120a first wire
120b second wire
130 support member
140 top board
150 return electrode
201 silicon substrate
202 silicon dioxide film
203 photoresist

### BEST MODE FOR CARRYING OUT THE INVENTION

Hereinafter, the best mode for carrying out the present invention will be explained for each embodiment in order with reference to the drawings.

Hereinafter, an embodiment of the probe of the present invention will be explained with reference to the drawings. Incidentally, in the embodiment below, as one specific example of the probe of the present invention, an explanation will be given for a recording/reproducing head (further, a recording/reproducing head array) for recording data into a dielectric recording medium or for reproducing the data recorded in the dielectric recording medium.

(1) Embodiment of Recording/Reproducing Head

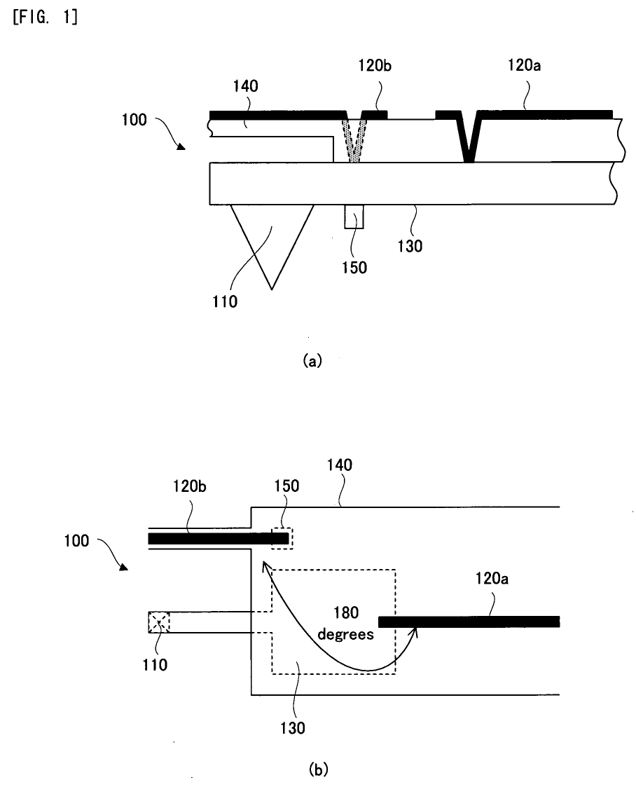

Firstly, with reference to FIG. 1 to FIG. 22, the embodiment of the recording/reproducing head of the present invention will be explained.

(i) Structure of Recording/Reproducing Head

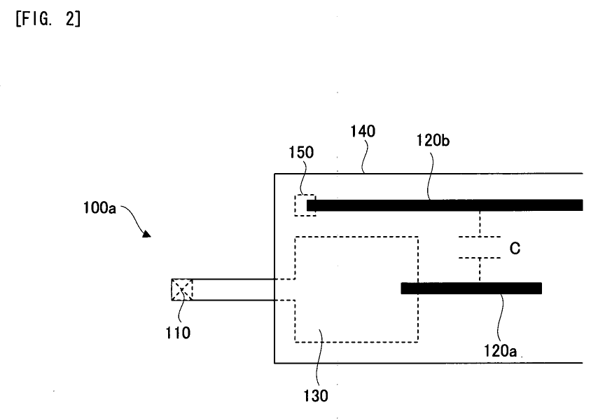

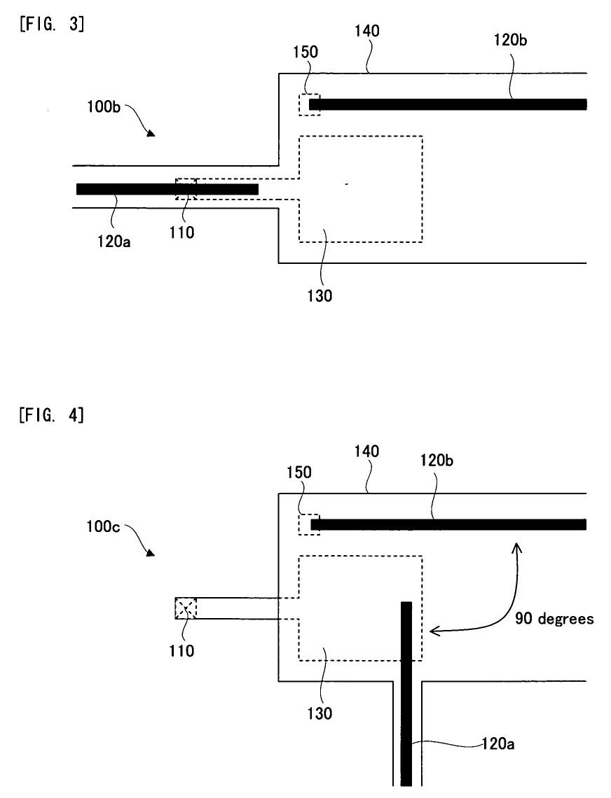

Firstly, with reference to FIG. 1 to FIG. 4, the structure (i.e. basic structure) of the recording/reproducing head in the embodiment will be explained. FIG. 1 are a side view and a plan view conceptually showing one specific example of the structure of the recording/reproducing head. Each of FIG. 2 and FIG. 3 is a plan view conceptually showing another specific example of the structure of the recording/reproducing head. FIG. 4 is a plan view conceptually showing the structure of a recording/reproducing head in a comparison example.

As shown in FIG. 1(a), a recording/reproducing head 100 in the embodiment is provided with: a support member 130 having a diamond tip 110; a first wire 120a; a second wire 120b; a top board 140; and a return electrode 150.

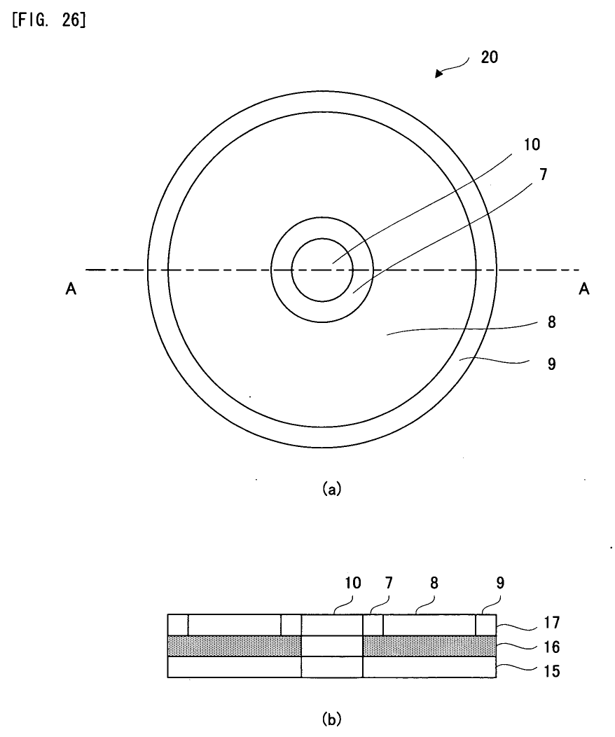

The diamond tip 110 is one specific example of the “projection portion” of the present invention, and has a sharp-pointed tip so as to apply an electric field to a dielectric recording medium 20 (refer to FIG. 26) described later from the tip side, at the time of recording/reproduction of the recording/reproducing head 100. The diamond tip 110 is provided with electrical conductivity particularly by doping boron or the like to diamond in the manufacturing thereof.

Incidentally, instead of the diamond tip 110, for example, boron nitride can be used as well. Alternatively, any member which is relatively hard and which has electrical conductivity (i.e. low resistant) can be used instead of the diamond tip 110.

The first wire 120a is constructed to supply to the diamond tip 110 an electric current necessary to apply an electric field from the diamond tip 110. Moreover, the second wire 120b is constructed to be connected to (i.e. to provide electrical continuity with) the return electrode 150.

In particular, the electric current supplied from the first wire 120a to the diamond tip 110 is preferably supplied with using the inside of the support member 130 as a path. In other words, it is preferable that the first wire 120a and the diamond tip 110 are not directly connected. Therefore, as described later, the support member 130 preferably has electrical conductivity. However, the first wire 120a and the diamond tip 110 may be also directly in contact. The same is true for the second wire 120b and the return electrode 150.

Each of the first wire 120a and the second wire 120b can employ alloy, such as, for example, platinum palladium and platinum iridium. Alternatively, as described later, it may employ aluminum, chromium, gold, or alloy of these metal or the like.

Moreover, each of the first wire 120a and the second wire 120b is formed on the top board 140. Thus, in order to further increase its adherence, a foundation layer may be provided on the top board 140, and each of the first wire 120a and the second wire 120b may be formed on the foundation layer. As the foundation layer, a metal thin film, such as titanium, can be used.

The support member 130 is one specific example of the “head portion” of the present invention, and is a basis for supporting the diamond tip 110. The support member 130 may or may not have electrical conductivity. However, as described above, considering that the path of the electric current supplied from the first wire 120a to the diamond tip 110 is preferably formed inside the support member 130, the support member 130 may have electrical conductivity. Moreover, as described later, the support member 130 and the diamond tip 110 may be unified (refer to FIG. 5, etc.).

As described later, the support member 130 constitutes one portion of a resonance circuit 14 at the time of reproduction, as one portion of a probe 11 (refer to FIG. 21). Thus, in order to obtain a desired resonance frequency, the material is more preferably selected depending on the inductance of the support member 130. Moreover, by selecting the material in this manner, the vibrational frequency of the probe 11 can be also changed, as occasion demands.

The top board 140 is constructed to adhere to the support member 130, and each of the first wire 120a and the second wire 120b is formed on the surface opposite to the surface where the top board 140 adheres to the support member 130. The top board 140 includes, for example, glass or the like, but it is not particularly limited to glass. Yet, the top board 140 preferably has insulation properties because it is disposed between each of the first wire 120a and the second wire 120b, and the support member 130.

The return electrode 150 is an electrode for returning thereto a high-frequency electric field (or alternating electric field), applied from the diamond tip 110 to a dielectric recording medium 20 described later. Incidentally, if the high-frequency electric field returns to the return electrode 150 without resistance, its shape and arrangement can be arbitrarily set. For example, it may be a ring-shaped plane electrode which surrounds the diamond tip 110, or an electrode having a projective shape like the diamond tip 110.

On the recording/reproducing head 100 in the embodiment, the first wire 120a and the second wire 120b extend in opposite directions to each other. The extensions of the first wire 120a and the second wire 120b will be explained in more detail, with reference to FIG. 1(b).

FIG. 1(b) is a plan view of the recording/reproducing head 100 shown in FIG. 1(a) when it is observed from the top side (i.e. the side where the first wire 120a and the second wire 120b are formed). As shown in FIG. 1(b), the first wire 120b extends in a direction opposite to the side where the diamond tip 110 is formed, of the recording/reproducing head 100 (i.e. to the right in FIG. 1(b)), whereas the second wire 120b extends in a direction of the side where the diamond tip 110 is formed, of the recording/reproducing head 100 (i.e. to the left in FIG. 1(b)). Namely, the first wire 120a and the second wire 120b extend with an angle difference of approximately 180 degrees.

In order to dispose the first wire 120a and the second wire 120b, the top board 140 has a shape extending in different directions. Namely, the top board 140 has a member extending in the direction opposite to the side where the diamond tip 110 of the recording/reproducing head 100 is formed, and a member extending in the direction of the side where the diamond tip 110 of the recording/reproducing head 100 is formed.

If, as in a recording/reproducing head 100a in a comparison example, the first wire 120a and the second wire 120b extend in the same direction, or extend side by side, then as shown in FIG. 2, floating capacitance C is generated between the first wire 120a and the second wire 120b to thereby cause crosstalk. Such a phenomenon, as described later, is not preferable on a dielectric recording/reproducing apparatus for detecting the dielectric constant of a dielectric material as a change in capacitance (particularly, small capacitance) of the dielectric material.

However, according to the recording/reproducing head 100 in the embodiment, the first wire 120a and the second wire 120b do not extend in the same direction nor extend side by side. Therefore, the floating capacitance generated between the first wire 120a and the second wire 120b can be reduced, or the generation thereof can be inhibited or prevented. Explaining it more specifically, as compared to the recording/reproducing head in the comparison example, the recording/reproducing head in the embodiment has an increased distance d between the first wire 120a and the second wire 120b. Thus, as is seen from the equation that the floating capacitance C=∈×(S/d) (wherein ∈ is a dielectric constant and S is a cross section), the floating capacitance is at least reduced on the recording/reproducing head 100 in the embodiment. Thus, it is possible to effectively avoid such a disadvantage that the floating capacitance generated between the first wire 120a and the second wire 120b causes a reproduction signal component to be weakened or a noise to mix. By this, the data can be reproduced, with higher accuracy or in high quality, on the dielectric recording/reproducing apparatus described later. Even in the recording operation, an electric field without the noise or the like caused by the floating capacitance can be preferably applied to the dielectric recording medium from the diamond tip 110, so that it is possible to record the data in higher quality.

Moreover, since the floating capacitance can be reduced, the diamond tip 110 and the return electrode 150 can be disposed more closely (or adjacent to each other). Namely, even if the diamond tip 110 and the return electrode 150 are closely disposed, the floating capacitance can be reduced, or the generation thereof can be inhibited or prevented, so that it is possible to preferably detect the dielectric constant of the dielectric material as the change in capacitance of the dielectric material. Moreover, since the diamond tip 110 and the return electrode 150 can be closely disposed, a feedback route of an oscillation circuit described later can be shorten. As a result, it is possible to effectively prevent the noise (e.g. the floating capacitance component) from entering into the oscillation circuit.

Incidentally, the first wire 120a and the second wire 120b are not necessarily disposed to extend in the directions opposite to each other as shown in FIG. 1. For example, as shown in FIG. 3, even in the case of a recording/reproducing head 100b in which the first wire 120a extends in the direction of the side where the diamond tip 110 of the recording/reproducing head 100b is formed (i.e. to the left in FIG. 3) whereas the second wire 120b extends in the direction opposite to the side where the diamond tip 110 of the recording/reproducing head 100b is formed (i.e. to the right in FIG. 3), it can receive the same various benefits as those of the recording/reproducing head 100 in the embodiment. Alternatively, as shown in FIG. 4, the first wire 120a and the second wire 120b may be constructed to extend with an angle difference of approximately 90 degrees. Alternatively, even in the case of a recording/reproducing head 100c in which the first wire 120a and the second wire 120b extend with a predetermined angle difference, it can receive the same various benefits as those of the recording/reproducing head 100 in the embodiment. These are summarized as follows: as long as the first wire 120a and the second wire 120b are not constructed to extend side by side (i.e. without an angle difference) as shown in FIG. 2, it can provide such a benefit that the floating capacitance can be reduced or the generation thereof can be inhibited or prevented. However, from the viewpoint of reducing the floating capacitance or inhibiting or preventing the generation thereof more effectively, the first wire 120a and the second wire 120b are preferably constructed to extend with a larger angle difference, preferably, for example, with an angle difference of 90 degrees or more, more preferably, with an angle difference of 120 degrees or more, and further preferably, with an angle difference of 180 degrees or more.

Moreover, the above-mentioned recording/reproducing head in the embodiment uses diamond (particularly, diamond to which impurities, such as boron, are doped), however, for example, silicon may be used for the recording/reproducing head. Alternatively, the member other than at least the diamond tip 110 may employ silicon. In this case, a SOI (Silicon On Insulator) substrate, a SOS (Silicon On Sapphire) substrate, or the like may be used to produce the recording/reproducing head.

Moreover, in the above-mentioned embodiment, each of the first wire 120a and the second wire 120b is a linear wire, but obviously, it may be a curved line, as occasion demands.

(ii) Manufacturing Method of Recording/Reproducing Head

Next, with reference to FIG. 5 to FIG. 21, a manufacturing method of manufacturing the recording/reproducing head in the embodiment will be explained. FIG. 5 to FIG. 21 are cross sectional views or plan views conceptually showing each of the processes of the manufacturing method of manufacturing the recording/reproducing head in the embodiment.

Incidentally, the recording/reproducing head manufactured by the manufacturing method explained herein is the one in which the diamond tip 110 and the support member 130 are unified. However, it will be obvious that even if the diamond tip 110 and the support member 130 are not unified, the recording/reproducing head can be manufactured in the same manufacturing method, and that such manufacturing method is included in the scope of the present invention.

Firstly, as shown in FIG. 5, a silicon substrate 201 is prepared. The silicon substrate 201 will be mainly the mold form of the recording/reproducing head. Incidentally, in subsequent processes, it is preferable to provide such a silicon substrate 201 that a silicon dioxide film is formed along (or in parallel with) the (100 surface) of a crystal lattice structure. This is to form the projective (or pyramid) shape of the diamond tip 110 by performing anisotropic etching, as described later. The silicon substrate 201 is referred to as a (100) substrate.

Then, as shown in FIG. 6, a silicon dioxide (SiO₂) film 202 is formed on the surfaces on the front and back sides of the silicon substrate 201. Here, the silicon dioxide film 202 may be formed on the surfaces by locating the silicon substrate 201 in a high-temperature oxidation atmosphere.

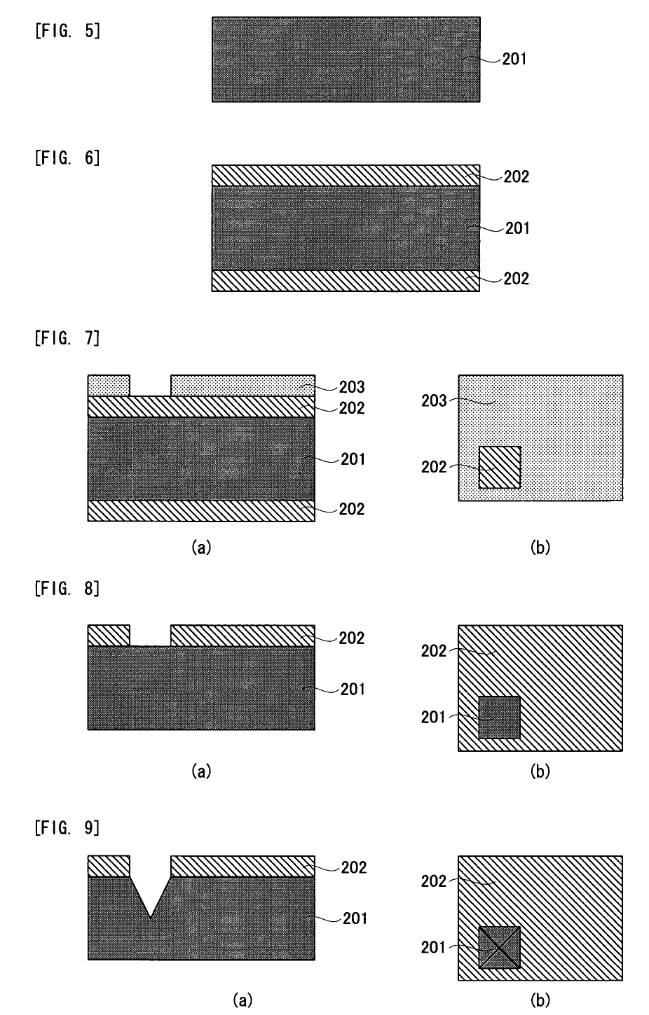

Then, as shown in FIG. 7(a), photoresist 203 is coated by spin coating, for example, and then patterning is performed. Specifically, after the photoresist 203 is coated on the silicon dioxide film 202, which is formed on one side of the silicon substrate 201, ultraviolet rays or the like are irradiated by using a photo mask which is patterned in accordance with the portion corresponding to the diamond tip 110. After that, by developing it, the patterning of the photoresist 203 is performed, as shown in FIG. 7(a). Of course, the patterning may be performed by using EB (Electron Beam) resist and other materials, for example.

Incidentally, FIG. 7(b) is a view showing the silicon substrate 201 and the like in FIG. 7(a) viewed from the top side (i.e. the side where the photoresist 203 is patterned). As shown in FIG. 7(b), in the portion where the diamond tip 110 of the recording/reproducing head 100 is formed, a window is formed by not applying the photoresist 203, so that the silicon dioxide film 202 can be seen. The diamond tip 110 is formed in accordance with the shape of the window.

Then, as shown in FIG. 8(a), etching is performed on the silicon substrate 201 on which the patterning of the photoresist 203 is performed in FIG. 7. The etching herein is performed in the portion where the photoresist 203 is not applied, out of the silicon dioxide film 202, by using BHF (Buffered HydroFluoric acid) and HF (HydroFluoric acid), for example. However, the etching may be performed by using another etchant, or the etching may be performed by dry etching.

After the etching of the silicon dioxide film 202, the photoresist 203 is removed. Here, the photoresist 203 may be removed by dry etching or wet etching.

FIG. 8(b) is a view showing the silicon substrate 201 and the like in FIG. 8(a) viewed from the top side. As shown in FIG. 8(b), in the portion where the diamond tip 110 is formed, a window is formed by removing the silicon dioxide film 202, so that the silicon substrate 201 can be seen.

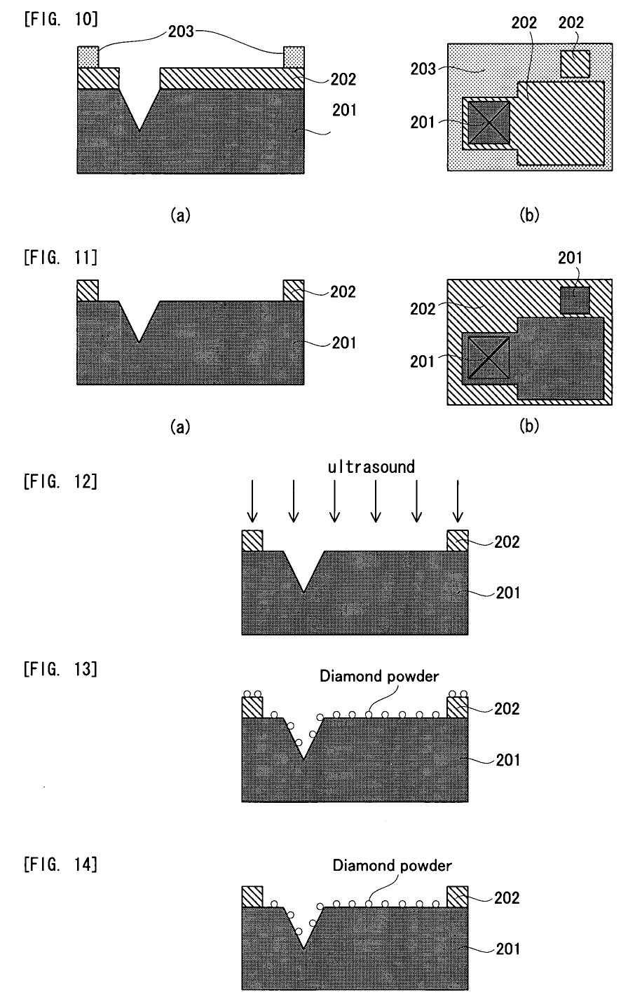

Then, as shown in FIG. 9(a), anisotropic etching is performed on the silicon substrate 201. Here, the anisotropic etching is performed by using alkaline etchant, such as TMAH (tetramethylammonium hydroxide) and KOH (potassium hydroxide), for example.

At this time, the silicon substrate 201 has such a character that the etching progresses in the normal direction of the (100) surface (i.e. a direction perpendicular to the silicon substrate 201 in FIG. 9(a)), whereas it is hard that the etching progresses in the normal direction of a (111) surface (i.e. a direction of about 45 degrees with respect to the silicon substrate 201 in FIG. 9(a)). The anisotropic etching is performed by using this character, to thereby etch the substrate 110 in the shape corresponding to the diamond tip 110 (i.e. in the projective or pyramid shape).

Incidentally, FIG. 9(b) is a view showing the silicon substrate 201 and the like in FIG. 9(a) viewed from the top side. As shown in FIG. 9(b), the anisotropic etching is performed on the silicon substrate 201, and the etching speed is smaller in the outer portion of the window of the silicon dioxide film 202, whereas the etching speed is larger in the portion of the center of the window. As a result, the hole formed by the etching has a sharp-pointed tip.

Incidentally, if the shape of the return electrode 150 is set into the projective shape like the diamond tip 110, it is necessary to perform the processes in FIG. 5 to FIG. 9 (particularly, the patterning of the photoresist 203 and the anisotropic etching, etc.) in order to form the return electrode 150.

Then, as shown in FIG. 10(a), the photoresist 203 is sprayed again for the patterning.

Incidentally, FIG. 10(b) is a view showing the silicon substrate 201 and the like in FIG. 10(a) viewed from the top side. As shown in FIG. 10(b), the photoresist 203 at this time is patterned in accordance with the shapes of the support member 130 and the return electrode 150.

Then, as shown in FIG. 11(a), the silicon dioxide film 202 is etched in accordance with the pattering of the photoresist 203 in FIG. 10, and then, the photoresist 203 is removed. Here, the etching is performed in the same procedure as in FIG. 8.

Incidentally, FIG. 11(b) is a view showing the silicon substrate 201 and the like in FIG. 11(a) viewed from the top side. As shown in FIG. 11(b), the silicon dioxide film 202 remains in accordance with the shape of the support member 130 and the like.

Then, as shown in FIG. 12, in methanol containing diamond powders, the diamond powders are vibrated by using ultrasound or the like, for example, to thereby scratch the surface of the silicon substrate 201 and the surface of the silicon dioxide film 202 formed thereon. Scratching the surfaces in this manner allows the formation of diamond nuclei in a subsequent process (refer to FIG. 13).

Then, as shown in FIG. 13, a diamond film is grown by hot filament CVD (Chemical Vapor Deposition). Namely, the diamond is selectively grown. For example, with CH₄ (methane) gas as a raw material, the diamond film is formed on the silicon substrate 201. In particular, the diamond film grows in the portions scratched in the process in FIG. 12. Incidentally, instead of the hot filament CVD, for example, microwave plasma CVD or another film growth method or the like may be used to grow the diamond film.

Moreover, the diamond film is used as the diamond tip 110 and the return electrode 150 described above, so that it needs to have electrical conductivity. Therefore, B (boron) is doped into the diamond film by adding doping gas, such as, for example, B₂H₆ (diborane) and (CH₃O)₃B (trimethoxyborane).

By adding the doping gas, such as diborane, it is also possible to provide electrical conductivity for the support member 130 or the like.

Incidentally, not limited to the method of growing the diamond film by the scratching process, as shown in FIG. 12, the diamond film may be grown by applying a negative bias voltage to the silicon substrate 201 at the initial stage of the CVD process. Alternatively, superfine particles of diamond powders may be applied onto the silicon substrate 201 to use them as the nuclei for the growth of the diamond film.

Then, as shown in FIG. 14, the diamond particles growing on the silicon dioxide film 202 are removed. In this regard, a slight amount of silicon dioxide film 202 is removed by the etching using, e.g., BHF or the like, resulting in the removal of the diamond particles. By this, it is possible to form the diamond tip 110, the return electrode 150, and the support member 130 in proper shapes.

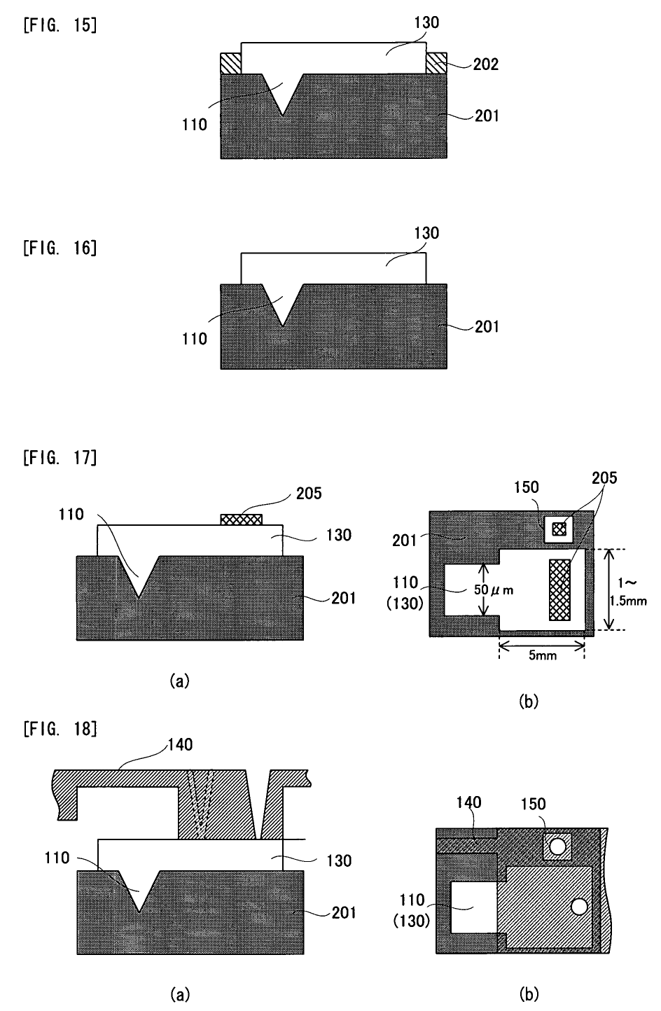

Then, as shown in FIG. 15, the diamond film is further grown by using, e.g., the hot filament CVD or the like, to thereby form the diamond tip 110, the return electrode 150, and the support member 130.

Incidentally, here, the support member 130 and the diamond tip 110 are unified. Thus, the explanation below will be given as the diamond tip 110 including the function as the support member 130.

Then, after the diamond tip 110 and the return electrode 150 are formed, as shown in FIG. 16, the etching is performed, to thereby remove the silicon dioxide film 202. Here, for example, BHF or the like is used to remove the silicon dioxide film 202.

Then, as shown in FIG. 17(a), in at least one portion of the return electrode 150 and the portion corresponding to the support member 130 out of the formed diamond tip 110, photosensitive polyimide 205 is formed on the surface on the opposite side to the side where the projective tip is formed. The photosensitive polyimide 205 is used for the connection to the top board 140 (refer to FIG. 18) for supporting or holding the entire recording/reproducing head 100, in a subsequent process.

Incidentally, FIG. 17(b) is a view showing the silicon substrate 201 and the like in FIG. 17(a) viewed from the top side. As shown in FIG. 17(b), the photosensitive polyimide 205 is formed on at least one portion of the return electrode 150 and the portion on the opposite side to the portion extending in the longitudinal direction (i.e. the portion where the diamond tip 110 is formed), out of the portion corresponding to the support member 130.

Incidentally, with regard to the specific size of the recording/reproducing head shown in FIG. 17(b), the portion extending in the longitudinal direction (i.e. the portion where the diamond tip 110 is formed) is preferably 50 μm or less in width. The portion on the opposite side to the portion extending in the longitudinal direction preferably has a size of approximately 5 mm×1 to 1.5 mm. However, it is not limited to these sizes. Moreover, the shape is not limited to the T-shape shown in FIG. 17(b), and may be another shape, such as a L-shape.

Then, as shown in FIG. 18(a), the top board 140 having a predetermined shape is attached to the photosensitive polyimide 205. The top board 140 is a member for supporting or holding the entire recording/reproducing head 100. Then, for example, an actuator or the like is connected to the top board 140. By this, at the time of recording/reproduction operation of the dielectric recording/reproducing apparatus described later, the recording/reproducing head 100 can be displaced on the dielectric recording medium.

Incidentally, if predetermined processing is performed on the top board 140, a cut or notch or the like may be formed in view of convenience of the processing. Moreover, the top board 140 has a hole for connecting the first wire 120a to the diamond tip 110 and a hole for the connecting the second sire 120b to the return electrode 150.

Incidentally, FIG. 18(b) is a view showing the silicon substrate 201 and the like in FIG. 18(a) viewed from the top side. As shown in FIG. 18(b), the top board 140 has a size large enough to cover at least one portion of the return electrode 150 and the diamond tip 110. However, the size of the top board 140 shown in FIG. 18(b) is just one example. Even if the top board 140 has a size less than this or a size greater than this, it is only necessary to have a size to the extent that it can support the entire recording/reproducing head 100.

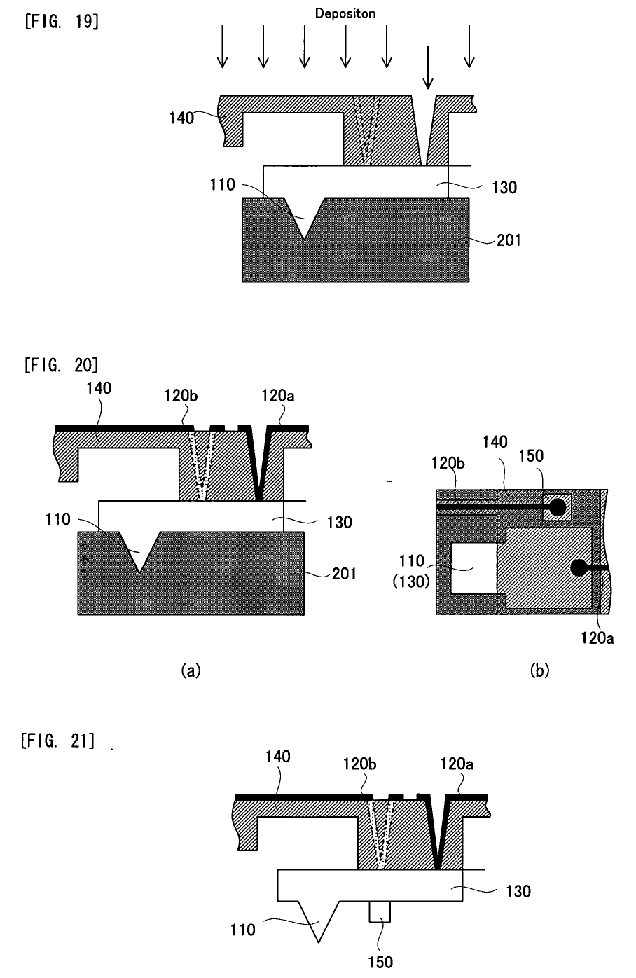

Then, as shown in FIG. 19, in order to form each of the first wire 120a and the second wire 120b, metal, such as, for example, aluminum, chromium, and gold, or alloy of these metal (or the above-mentioned alloy, such as platinum palladium and platinum iridium) or the like is deposited. At this time, metal or the like is preferably deposited, after the patterning of the photoresist 203 or the like is performed to the portion except for the portion where the first wire 120a and the second wire 120b are to be formed.

Then, as a result of the deposition, as shown in FIG. 20(a), each of the first wire 102a and the second wire 120b is formed.

Incidentally, FIG. 20(b) is a view showing the silicon substrate 201 and the like in FIG. 20(a) viewed from the top side. As shown in FIG. 20(b), the first wire 120a is formed to extend in the direction opposite to the diamond tip 110 out of the recording/reproducing head 100, whereas the second wire 120b is formed to extend in the direction of the diamond tip 110 out of the recording/reproducing head 100.

The pattern of each of the first wire 102a and the second wire 120b can be arbitrarily formed in accordance with the patterning in the deposition of metal in FIG. 19.

Then, as shown in FIG. 21, the silicon substrate 201 is removed. Here, RIE (Reactive Ion Etching) or plasma CVD with using SF₆ as the etching gas is used to remove the silicon substrate 201 from the diamond tip 110 and the return electrode 150. However, another method may be used to remove the silicon substrate 201. By this, the recording/reproducing head in the embodiment is manufactured.

Incidentally, the manufacturing method explained in FIG. 5 to FIG. 21, i.e. the manufacturing method in the embodiment, is merely one specific example. The raw material and various methods (e.g. the etching method, film forming method, and film growth method) used in each process can be changed, as occasion demands.

(iii) Another Embodiment of Recording/Reproducing Head

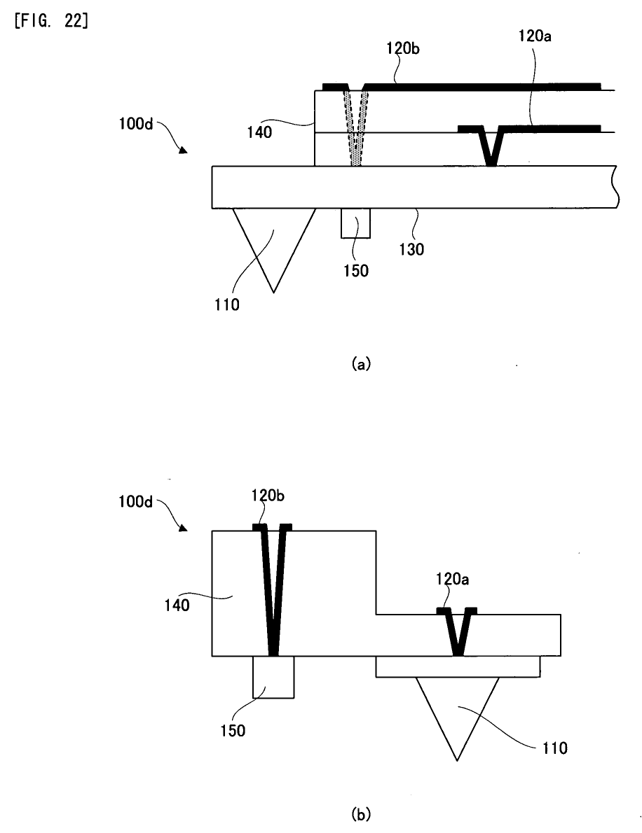

Next, with reference to FIG. 22, another embodiment of the recording/reproducing head will be explained. FIG. 22 are a side view and a front view conceptually showing the structure of the recording/reproducing head in another embodiment.

As shown in FIG. 22(a), in a recording/reproducing head 100d in another embodiment, the first wire 120a and the second wire 120b are formed at different heights on the top board 140. Namely, the first wire 120a is formed on a lower plane, as compared to the second wire 120b.

FIG. 22(b) is a view showing the recording/reproducing head 100d shown in FIG. 22(a) viewed from the front side. As shown in FIG. 22(b), for example, based on the horizontal position of the recording/reproducing head 100d (or the recording surface of the dielectric recording medium described later), the height at which the first wire 120a is formed and the height at which the second wire 120b is formed are different from each other.

Even the recording/reproducing head 100d having such a structure, has a relatively increased distance between the first wire 120a and the second wire 120b, as compared to, for example, the recording/reproducing head on which the first wire 120a and the second wire 120b are at the same plane. Thus, the generation of the floating capacitance can be inhibited or prevented, and it is possible to receive the same various benefits as those of the above-mentioned recording/reproducing head 100 in the embodiment.

In addition, one portion of the top board 140 is disposed between the first wire 120a and the second wire 120b, so that it is possible to more effectively reduce or inhibit the floating capacitance which can be generated between the first wire 120a and the second wire 120b. From this point, the top board 140 preferably has insulation properties.

Moreover, although the height (or thickness) of the recording/reproducing head 100d is increased, the directions of the wires can be set equal (i.e. the angle difference between the first wire 120a and the second wire 120b can be eliminated), so that the width or length of the recording/reproducing head 100d can be reduced. This leads to an advantage of manufacturing of a smaller recording/reproducing head.

Incidentally, in the above-mentioned another embodiment, each of the first wire 120a and the second wire 120b extends on one plane (i.e. at one height). Of course, each of them may extend at a different height, as occasion demands. The point is that as long as the first wire 120a and the second wire 120b do not extend in parallel on the same height plane, it is possible to receive the above-mentioned various benefits.

Moreover, the more greatly the height at which the first wire 120 extends and the height at which the second wire 120b extends vary, the more effectively the floating capacitance can be reduced or the like. For example, great reduction or the like of the floating capacitance cannot be expected from only the difference in height caused by the small unevenness of the surface of the top board 140, and it is preferable to provide a greater difference of altitude or elevation. For example, in order to provide a desired difference of altitude, the artificially processed top board 140 is preferably used.

(2) Embodiment of Recording/Reproducing Head Array

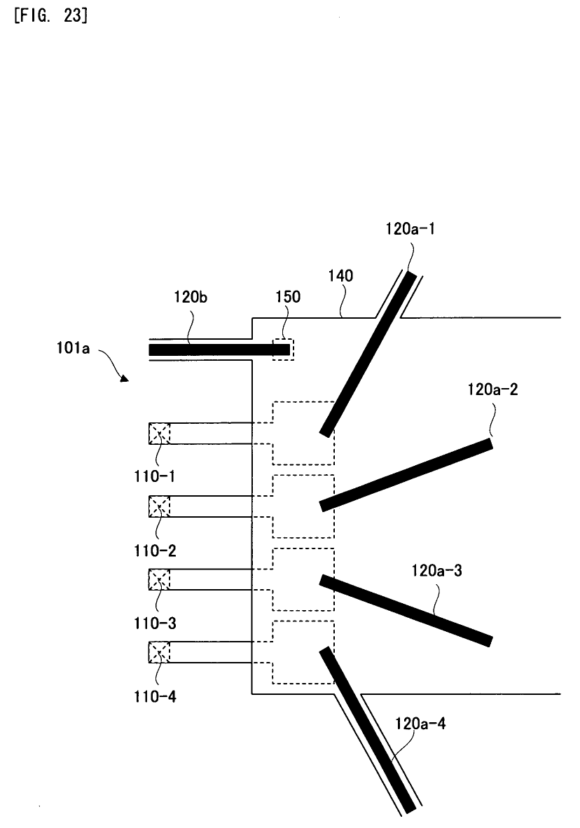

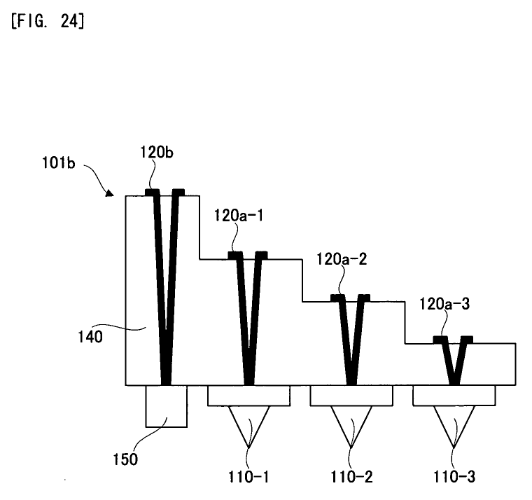

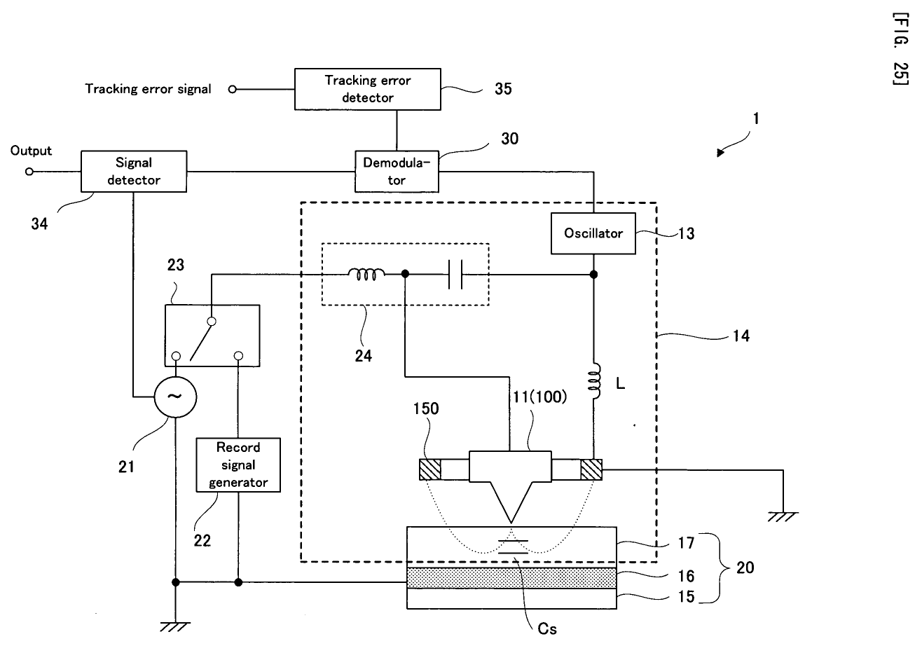

Next, with reference to FIG. 23 and FIG. 24, an explanation will be given for a recording/reproducing head array as an embodiment of the probe of the present invention. FIG. 23 is a side view and a plan view conceptually showing one embodiment of a recording/reproducing head array. FIG. 24 is a side view and a plan view conceptually showing another embodiment of the recording/reproducing head array.

A recording/reproducing head array 101a shown in FIG. 23 is provided with a plurality of diamond tips 110-1, 110-2, 110-3, and 110-4. Then, a first wire 120a-1 connected to the diamond tip 110-1, a first wire 120a-2 connected to the diamond tip 110-2, a first wire 120a-3 connected to the diamond tip 110-3, and a first wire 120a-4 connected to the diamond tip 110-4 are formed to extend in different directions from each other.

Even the recording/reproducing head array 101a provided with the plurality of diamond tips 110, as described above, can receive the same various benefits as those of the recording/reproducing head 100 in the embodiment by employing the same structure as that of the recording/reproducing head 100 in the embodiment described above (i.e. such a structure that each wire extends in a different direction).

Moreover, in a recording/reproducing head array 101b shown in FIG. 24, the wires connected to the respective diamond tips 110-1 to 110-4 and the wire connected to the return electrode 150 are formed at different heights on the top board 140 from each other. Even in such construction, it is possible to receive the same various benefits as those of the recording/reproducing head 100 (particularly 100d) in the embodiment.

In addition, by employing the structure like the recording/reproducing head array 100b shown in FIG. 24, it is possible to reduce the width and length of the recording/reproducing head array 100b. Thus, there is also an advantage of manufacturing of a smaller recording/reproducing head array.

Incidentally, the above-mentioned recording/reproducing head array has such a structure that a single return electrode 150 is provided, but it may have such a structure that a plurality of return electrodes are provided. Even the recording/reproducing head array provided with the plurality of return electrodes can receive the same various benefits as those of the above-mentioned recording/reproducing head array in the embodiment, if a plurality of wires connected to the respective diamond tips and a plurality of wires connected to the respective return electrodes extend in different directions from each other (or are formed at different heights from each other). Incidentally, in case of such a recording/reproducing head array that at least two of the plurality of wires extend in different direction from each other (or at least two wires are formed at different heights), it is possible to properly receive the same various benefits as those of the above-mentioned recording/reproducing head array in the embodiment. Namely, the generation of the floating capacitance can be properly reduced or inhibited.

(3) Embodiment of Recording/Reproducing Apparatus

Next, with reference to FIG. 25 to FIG. 28, a recording/reproducing apparatus which uses the above-mentioned recording/reproducing head in the embodiment will be explained.

(i) Basic Structure

Firstly, the basic structure of a dielectric recording/reproducing apparatus in this embodiment will be explained, with reference to FIG. 25. FIG. 25 is a block diagram conceptually showing the basic structure of the dielectric recording/reproducing apparatus in the embodiment.

A dielectric reproducing/reproducing apparatus 1 is provided with: a probe 11 for applying an electric field, with its tip portion facing or opposed to a dielectric material 17 of a dielectric recording medium 20; a return electrode 150 for returning thereto a high-frequency electric field for signal reproduction, applied from the probe 11; an inductor L disposed between the probe 11 and the return electrode 150; an oscillator 13 which oscillates at a resonance frequency determined from the inductor L and a capacitance Cs of a portion which is polarized in accordance with record information and which is formed in the dielectric material 17 under the probe 11; an alternating current (AC) signal generator 21 for applying an alternating electric field to detect the state of the polarization recorded in the dielectric material 17; a record signal generator 22 for recording the polarization state into the dielectric material; a switch 23 for changing the outputs of the AC signal generator 21 and the record signal generator 22; a HPF (High Pass Filter) 24; a demodulator 30 for demodulating a FM signal modulated by the capacitance corresponding to the polarization state owned by the dielectric material 17 under the probe 11; a signal detector 34 for detecting data from the demodulated signal; a tracking error detector 35 for detecting a tracking error signal from the demodulated signal; and the like.

As the probe 11, the above-mentioned recording/reproducing head 100 in the embodiment or the like is used. The probe 11 is connected to the oscillator 13 through the HPF 24, and is connected to the AC signal generator 21 and the record signal generator 22 through the HPF 24 and the switch 23. Then, it functions as an electrode for applying an electrical field to the dielectric material 17. Incidentally, as the probe 11, for example, a needle type shown in FIG. 1 and the like, or a cantilever type or the like is known as its specific shape.

Incidentally, as the probe 11, the above-mentioned recording/reproducing head array 101 in the embodiment may be used. In this case, a plurality of AC signal generators 21 are preferably provided in association with the respective diamond tips 110. Moreover, in order to discriminate reproduction signals corresponding to the AC signal generators 21 on the signal detector 34, it is preferable that a plurality of signal detectors 34 are provided, and that the signal detectors 34 obtain reference signals from the respective AC signal generators 21, to thereby output the corresponding reproduction signals.

The return electrode 150 is an electrode for returning thereto the high-frequency electric field applied to the dielectric material 17 from the probe 11 (i.e. a resonance electric field from the oscillator 13), and is disposed to surround the probe 11.

The inductor L is disposed between the probe 11 and the return electrode 150, and may be formed from a microstripline, for example. A resonance circuit 14 is constructed including the inductor L and the capacitance Cs. The inductance of the inductor L is determined such that this resonance frequency is a value which is centered on approximately 1 GHz, for example.

The oscillator 13 is an oscillator which oscillates at the resonance frequency determined from the inductor L and the capacitance Cs. The oscillation frequency varies, depending on the change of the capacitance Cs. Therefore, FM modulation is performed correspondingly to the change of the capacitance Cs determined by a polarization domain corresponding to the recorded data. By demodulating this FM modulation, it is possible to read the data recorded in the dielectric recording medium 20.

Incidentally, as described in detail later, the probe 11, the return electrode 150, the oscillator 13, the inductor L, the HPF 24, and the capacitance Cs of the dielectric material 17 constitute the resonance circuit 14, and the FM signal amplified in the oscillator 13 is outputted to the demodulator 30.

The AC signal generator 21 applies an alternating electric field between the return electrode 150 and an electrode 16. Moreover, in the dielectric recording/reproducing apparatus which uses a plurality of probes 11, the frequencies of the alternating electric fields are used as reference signals for synchronization, to thereby discriminate signals detected with the probes 11. The frequencies are centered on about 5 kHz. In that condition, the alternating electric fields are applied to the domains of the dielectric material 17.

The record signal generator 22 generates a signal for recording and supplies it to the probe 11 at the time of recording. This signal is not limited to a digital signal and it may be an analog signal. The signal includes various signals, such as audio information, video information, and digital data for a computer. Moreover, the AC signal superimposed on the record signal is used to discriminate and reproduce the information on each probe, as the reference signal at the time of signal reproduction.

The switch 23 selects the output so as to supply, to the probe 11, the signal from the AC signal generator 21 at the time of reproduction and the signal from the record signal generator 23 at the time of recording. As this apparatus, a mechanical relay and a semiconductor circuit are used. The switch 23 is preferably constructed from the relay in the case of the analog signal, and the semiconductor circuit in the case of the digital signal.

The HPF 24 includes an inductor and a condenser, and is used to form a high pass filter for cutting off a signal system so that the signals from the AC signal generator 21 and the record signal generator 22 do not interfere with the oscillation of the oscillator 13. The cutoff frequency is f=½π√ {LC}. Here, L is the inductance of the inductor included in the HPF 24, and C is the capacitance of the condenser included in the HPF 24. The frequency of the AC signal is about 5 KHz, and the oscillation frequency of the oscillator 13 is about 1 GHz. Thus, the separation is sufficiently performed with the first order LC filter. A higher-order filter may be used, but the number of elements increases, so that there is a possibility that the apparatus becomes bigger.

The demodulator 30 demodulates the oscillation frequency of the oscillator 13, which is FM-modulated due to the small change of the capacitance Cs, and reconstructs a waveform corresponding to the polarized state of a portion which is traced by the prove 11. If the recorded data are digital data of “0” and “1”, there are two types of frequencies to be demodulated. By judging the frequency, the data reproduction is easily performed.

The signal detector 34 reproduces the recorded data from the signal demodulated on the demodulator 30. A lock-in amplifier is used as the signal detector 34, for example, and coherent detection or synchronized detection is performed on the basis of the frequency of the alternating electric field of the AC signal generator 21, to thereby reproduce the data. Incidentally, it will be obvious that another phase detection device may be used.

The tracking error detector 35 detects a tracking error signal for controlling the apparatus, from the signal demodulated on the demodulator 30. The detected tracking error signal is inputted into a tracking mechanism for the control.

Next, one example of the dielectric recording medium 20 shown in FIG. 25 will be explained with reference to FIG. 26. FIG. 26 are a plan view and a cross sectional view conceptually showing one example of the dielectric recording medium 20 used in the embodiment.

As shown in FIG. 26(a), the dielectric recording medium 20 is a disc-shaped dielectric recording medium, and is provided with: for example, a center hole 10; and an inner area 7, a recording area 8, and an outer area 9, which are located concentrically from the center hole 10 in this order. The center hole 10 is used in the case where the dielectric recording medium 20 is mounted on a spindle motor or in a similar case.

The recording area 8 is an area to record the data therein and has tracks and spaces between the tracks. Moreover, on the tracks and the spaces, there is an area to record therein control information associated with the record and reproduction. Furthermore, the inner area 7 and the outer area 9 are used to recognize the inner position and the outer position of the dielectric recording medium 20, respectively, and can be used as areas to record therein information about the data to be recorded, such as a title, its address, a recording time length, and a recording capacity. Incidentally, the above-described structure is one example of the dielectric recording medium 20, and another structure, such as a card-shape, can be also employed.

Moreover, as shown in FIG. 26(b), the dielectric recording medium 20 is formed such that the electrode 16 is laminated on a substrate 15 and that the dielectric material 17 is laminated on the electrode 16.

The substrate 15 is Si (silicon), for example, which is a preferable material in its strength, chemical stability, workability, or the like. The electrode 16 is intended to generate an electric field between the electrode 16 and the probe 11 (or the return electrode 150). By applying such an electric field which is equal to or stronger than the coercive electric field of the dielectric material 17 to the dielectric material 17, the polarization direction is determined. By determining the polarization direction in accordance with the data, the recording is performed.

The dielectric material 17 is formed onto the electrode 16, by a known technology, such as spattering LiTaO₃ or the like, which is a ferroelectric substance. Then, the recording is performed with respect to the Z surface of LiTaO₃ in which the plus and minus surfaces of the polarization have a 180-degree domain relationship. It will be obvious that another dielectric material may be used. In the dielectric material 17, the small polarization is formed at high speed, by a voltage for data, which is applied simultaneously with a direct current bias voltage.

Moreover, as the shape of the dielectric recoding medium 20, for example, there are a disc shape and a card shape and the like. The displacement of the relative position with respect to the probe 11 is performed by the rotation of the medium, or by displacing either the probe 11 or the medium linearly.

(ii) Operation Principle

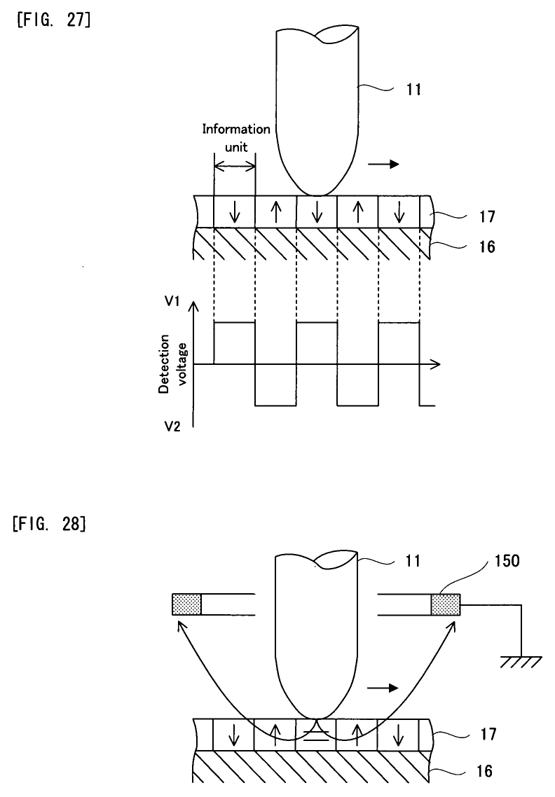

Next, with reference to FIG. 27 and FIG. 28, the operation principle of the dielectric recording/reproducing apparatus 1 in the embodiment will be explained. Incidentally, in the explanation below, one portion of the constituent elements of the dielectric recording/reproducing apparatus 1 shown in FIG. 25 is extracted and explained.

(Recording Operation)

Firstly, with reference to FIG. 27, the recording operation of the dielectric recording/reproducing apparatus in the embodiment will be explained. FIG. 27 is a cross sectional view conceptually showing the information recording operation.

As shown in FIG. 27, by applying an electric field which exceeds the coercive electric field of the dielectric material 17 between the probe 11 and the electrode 16, the dielectric material 17 is polarized having a direction corresponding to the direction of the applied electric field. Then, by controlling an applying voltage to thereby change the polarization direction, it is possible to record the predetermined information. This uses such a characteristic that the polarization direction is reversed if an electric field which exceeds the coercive electric field of a dielectric substance is applied to the dielectric substance (particularly, a ferroelectric substance), and that the polarization direction is maintained.

For example, it is assumed that when an electric field which directs from the probe 11 to the electrode 16 is applied, the micro domain has downward polarization P, and that when an electric field which directs from the electrode 16 to the probe 11 is applied, the micro domain has upward polarization P. This corresponds to the state that the data information is recorded. If the probe 11 is operated in an arrow-pointing direction, a detection voltage is outputted as a square wave which swings up and down in accordance with the polarization P. Incidentally, this level changes depending on the polarization extent of the polarization P, and can be recorded as an analog signal.

Particularly in the embodiment, the above-mentioned recording/reproducing head 100 or the like in the embodiment is used as the probe 11, so that an electric field without the noise caused by the floating capacitance can be preferably applied to the dielectric recording medium from the diamond tip 110. Thus, it is possible to record the data in higher quality.

(Reproduction Operation)

Next, with reference to FIG. 28, the reproduction operation of the dielectric recording/reproducing apparatus 1 in the embodiment will be explained. FIG. 28 is a cross sectional view conceptually showing the information reproduction operation.

The nonlinear dielectric constant of a dielectric substance changes in accordance with the polarization direction of the dielectric substance. The nonlinear dielectric constant of the dielectric substance can be detected as a difference in the capacitance of the dielectric substance or a difference in the change of the capacitance of the dielectric substance, when an electric field is applied to the dielectric substance. Therefore, by applying an electric field to the dielectric material and by detecting a difference in the capacitance Cs or a difference in the change of the capacitance Cs in a certain domain of the dielectric material at that time, it is possible to read and reproduce the data recorded as the polarization direction of the dielectric material.

Specifically, firstly, as shown in FIG. 28, an alternating electric field from the not-illustrated AC signal generator 21 is applied between the electrode 16 and the probe 11. The alternating electric field has an electric field strength which does not exceed the coercive electric field of the dielectric material 17, and has a frequency of approximately 5 kHz, for example. The alternating electric field is generated mainly to discriminate the difference in the change of the capacitance corresponding to the polarization direction of the dielectric material 17. Incidentally, instead of the alternating electric field, a direct current bias voltage may be applied to form an electric field in the dielectric material 17. The application of the alternating electric field causes the generation of an electric field in the dielectric material 17 of the dielectric recording medium 20.

Then, the probe 11 is put closer to a recording surface until the distance between the tip of the probe 11 and the recording surface becomes extremely small on the order of nanometers. Under this condition, the oscillator 13 is driven. Incidentally, in order to detect the capacitance Cs of the dielectric material 17 under the probe 11 highly accurately, it is preferable to contact the probe 11 with the surface of the dielectric material 17, i.e. the recording surface. However, in order to read the data recorded in the dielectric material 17 at high speed, it is necessary to relatively displace the probe 11 at high speed on the dielectric recording medium 20. Thus, considering the possibility of the high-speed displacement, the prevention of damage caused by collision and friction between the probe 11 and the dielectric recording medium 20, or the like, it is practically better to put the probe 11 closer to the recording surface to the extent that it can be regarded as the contact, rather than to contact the probe 11 with the recording surface.

Then, the oscillator 13 oscillates at the resonance frequency of the resonance circuit, which includes the inductor L and the capacitance Cs associated with the dielectric material 17 under the probe 11 as the constituent factors. The center frequency of the resonance frequency is set to approximately 1 GHz, as described above.

Here, the return electrode 150 and the probe 11 constitute one portion of the oscillation circuit 14 including the oscillator 13. The high-frequency signal of approximately 1 GHz, which is applied to the dielectric material 17 from the probe 11, passes through the dielectric material 17 and returns to the return electrode 150, as shown by solid lines in FIG. 28. By disposing the return electrode 150 in the vicinity of the probe 11 and shortening a feedback route to the oscillation circuit including the oscillator 13, it is possible to reduce the noise (e.g. a floating capacitance component) entering the oscillation circuit.

In addition, the change of the capacitance Cs corresponding to the nonlinear dielectric constant of the dielectric material 17 is extremely small. In order to detect this change, it is necessary to adopt a detection method having high detection accuracy. In a detection method using FM modulation, the high detection accuracy can be generally obtained, but it is necessary to further improve the detection accuracy, in order to make it possible to detect the small capacitance change corresponding to the nonlinear dielectric constant of the dielectric material 17. Thus, in the dielectric recording/reproducing apparatus in the embodiment (i.e. recording/reproducing apparatus which uses the SNDM principle), the return electrode 150 is located in the vicinity of the probe 11 to shorten the feedback route to the oscillation circuit as much as possible. By this, it is possible to obtain extremely high detection accuracy, and thus it is possible to detect the small capacitance change corresponding to the nonlinear dielectric constant of the dielectric substance.

After the oscillator 13 is driven, the probe 11 is displaced in parallel with the recording surface on the dielectric recording medium 20. By the displacement, the domain of the dielectric material 17 under the probe 11 is changed, and whenever the polarization direction thereof changes, the capacitance Cs changes. If the capacitance Cs changes, the resonance frequency, i.e. the oscillation frequency of the oscillator 13, changes. As a result, the oscillator 13 outputs a signal which is FM-modulated on the basis of the change of the capacitance Cs.

This FM signal is frequency-voltage converted by the demodulator 30. As a result, the change of the capacitance Cs is converted to the extent of the voltage. The change of the capacitance Cs corresponds to the nonlinear dielectric constant of the dielectric material 17, and the nonlinear dielectric constant corresponds to the polarization direction of the dielectric material 17, and the polarization direction corresponds to the data recorded in the dielectric material 17. Therefore, the signal obtained from the demodulator 30 is such a signal that the voltage changes in accordance with the data recorded in the dielectric recording medium 20. Moreover, the signal obtained from the demodulator 30 is supplied to the signal detector 34, and, for example, coherent detection or synchronized detection is performed, to thereby extract the data recorded in the dielectric recording medium 20.

At this time, on the signal detector 34, an alternating current signal generated by the AC signal generator 21 is used as the reference signal. By this, for example, even if the signal obtained from the demodulator 30 includes many noises or the data to be extracted is a weak signal, the data can be extracted highly accurately by performing the synchronization with the reference signal, as described later.

Particularly in the embodiment, the recording/reproducing head 100 or the like shown in FIG. 1 or the like is used as the probe 11. Thus, the floating capacitance which is likely generated between the first wire 120a and the second wire 120b can be reduced, or the generation thereof can be inhibited or prevented. Therefore, the dielectric constant of the dielectric material can be detected with high accuracy or in high quality as the change of the capacitance Cs of the dielectric material. Thus, the reproduction quality of the dielectric recording/reproducing apparatus 1 can be improved.

Moreover, in the above-mentioned embodiment, the dielectric material 17 is used as the recording layer. From the viewpoint of the presence or absence of the nonlinear dielectric constant and spontaneous polarization, the dielectric material 17 is preferably a ferroelectric substance.

Moreover, in the present invention, various changes may be made, if desired, without departing from the essence or spirit of the invention which can be read from the claims and the entire specification. A probe, a recording apparatus, a reproducing apparatus, and a recording/reproducing apparatus, which involve such changes, are also intended to be within the technical scope of the present invention.

### INDUSTRIAL APPLICABILITY

The probe of the present invention can be applied to, for example, a probe used as a recording/reproducing head for recording and reproducing polarization information recorded in a dielectric substance, such as a ferroelectric recording medium. The recording apparatus, the reproducing apparatus, and the recording/reproducing apparatus which use the probe of the present invention can be applied to a recording/reproducing apparatus which uses SNDM.

1. A probe comprising:
a head portion including a projection with its tip facing a medium;
a return electrode for returning thereto an electric field applied from the projection;
a first wire extending in predetermined one direction so as to be connected to the projection; and
a second wire extending in another direction different from the one direction so as to be connected to said return electrode.

2. The probe according to claim 1, wherein the one direction and the another direction have an angle difference of at least 90 degrees or more.

3. The probe according to claim 1, wherein the one direction and the another direction are opposite.

4. The probe according to claim 1, wherein each of said first wire and said second wire extends on the same plane.

5. A probe comprising:
a head portion including a projection with its tip facing a medium;
a return electrode for returning thereto an electric field applied from the projection;
a first wire extending on predetermined one plane so as to be connected to the projection; and
a second wire extending on another plane at a different height from that of the one plane so as to be connected to said return electrode.

6. The probe according to claim 5, wherein each of said first wire and said second wire extends in the same direction.

7. The probe according to claim 1, further comprising a top board for supporting at least one of said first wire and said second wire.

8. The probe according to claim 5, further comprising a top board for supporting at least one of said first wire and said second wire.

9. The probe according to claim 1, wherein the projection and said return electrode are adjacent to each other.

10. The probe according to claim 5, wherein the projection and said return electrode are adjacent to each other.

11. The probe according to claim 1, wherein said head portion includes diamond to which impurities are doped.

12. The probe according to claim 5, wherein said head portion includes diamond to which impurities are doped.

13. A probe comprising:
a head portion including a plurality of projections with each of their tips facing a medium;
at least one return electrode for returning thereto an electric field applied from at least one of the plurality of projections;
a plurality of first wires extending in different directions from each other so as to be connected to the respective projections; and
a second wire extending in a different direction from the directions in which said plurality of first wires extend so as to be connected to said at least one return electrode.

14. A probe comprising:
a head portion including plurality of projections with each of their tips facing a medium;
at least one return electrode for returning thereto an electric field applied from at least one of the plurality of projections;
a plurality of first wires extending on different planes from each other so as to be connected to the respective projections; and
a second wire extending on a plane at a different height from those of the planes on which said plurality of first wires extend so as to be connected to said at least one return electrode.

15. A recording apparatus for recording data into a dielectric recording medium, said recording apparatus comprising:
the probe according to claim 1; and
a record signal generating device for generating a record signal corresponding to the data.

16. A recording apparatus for recording data into a dielectric recording medium, said recording apparatus comprising:
the probe according to claim 5; and
a record signal generating device for generating a record signal corresponding to the data.

17. A recording apparatus for recording data into a dielectric recording medium, said recording apparatus comprising:
the probe according to claim 13; and
a record signal generating device for generating a record signal corresponding to the data.

18. A recording apparatus for recording data into a dielectric recording medium, said recording apparatus comprising:
the probe according to claim 14; and
a record signal generating device for generating a record signal corresponding to the data.

19. A reproducing apparatus for reproducing data recorded in a dielectric recording medium, said reproducing apparatus comprising:
the probe according to claim 1;
an electric field applying device for applying an electric field to the dielectric recording medium;
an oscillating device whose oscillation frequency varies depending on a difference in capacitance corresponding to a nonlinear dielectric constant of the dielectric recording medium; and
a reproducing device for demodulating an oscillation signal generated by said oscillating device and reproducing the data.

20. A reproducing apparatus for reproducing data recorded in a dielectric recording medium, said reproducing apparatus comprising:
the probe according to claim 5;
an electric field applying device for applying an electric field to the dielectric recording medium;
an oscillating device whose oscillation frequency varies depending on a difference in capacitance corresponding to a nonlinear dielectric constant of the dielectric recording medium; and
a reproducing device for demodulating an oscillation signal generated by said oscillating device and reproducing the data.

21. A reproducing apparatus for reproducing data recorded in a dielectric recording medium, said reproducing apparatus comprising:
the probe according to claim 13;
an electric field applying device for applying an electric field to the dielectric recording medium;
an oscillating device whose oscillation frequency varies depending on a difference in capacitance corresponding to a nonlinear dielectric constant of the dielectric recording medium; and
a reproducing device for demodulating an oscillation signal generated by said oscillating device and reproducing the data.

22. A reproducing apparatus for reproducing data recorded in a dielectric recording medium, said reproducing apparatus comprising:
the probe according to claim 14;
an electric field applying device for applying an electric field to the dielectric recording medium;
an oscillating device whose oscillation frequency varies depending on a difference in capacitance corresponding to a nonlinear dielectric constant of the dielectric recording medium; and
a reproducing device for demodulating an oscillation signal generated by said oscillating device and reproducing the data.

23. A recording/reproducing apparatus for recording data into a dielectric recording medium and reproducing the data recorded in the dielectric recording medium, said recording/reproducing apparatus comprising:
the probe according to claim 1;
a record signal generating device for generating a record signal corresponding to the data;
an electric field applying device for applying an electric field to the dielectric recording medium;
an oscillating device whose oscillation frequency varies depending on a difference in capacitance corresponding to a nonlinear dielectric constant of the dielectric recording medium; and
a reproducing device for demodulating an oscillation signal generated by said oscillating device and reproducing the data.

24. A recording/reproducing apparatus for recording data into a dielectric recording medium and reproducing the data recorded in the dielectric recording medium, said recording/reproducing apparatus comprising:
the probe according to claim 5;
a record signal generating device for generating a record signal corresponding to the data;
an electric field applying device for applying an electric field to the dielectric recording medium;
an oscillating device whose oscillation frequency varies depending on a difference in capacitance corresponding to a nonlinear dielectric constant of the dielectric recording medium; and
a reproducing device for demodulating an oscillation signal generated by said oscillating device and reproducing the data.

25. A recording/reproducing apparatus for recording data into a dielectric recording medium and reproducing the data recorded in the dielectric recording medium, said recording/reproducing apparatus comprising:
the probe according to claim 13;
a record signal generating device for generating a record signal corresponding to the data;
an electric field applying device for applying an electric field to the dielectric recording medium;
an oscillating device whose oscillation frequency varies depending on a difference in capacitance corresponding to a nonlinear dielectric constant of the dielectric recording medium; and
a reproducing device for demodulating an oscillation signal generated by said oscillating device and reproducing the data.

26. A recording/reproducing apparatus for recording data into a dielectric recording medium and reproducing the data recorded in the dielectric recording medium, said recording/reproducing apparatus comprising:
the probe according to claim 14;
a record signal generating device for generating a record signal corresponding to the data;
an electric field applying device for applying an electric field to the dielectric recording medium;
an oscillating device whose oscillation frequency varies depending on a difference in capacitance corresponding to a nonlinear dielectric constant of the dielectric recording medium; and
a reproducing device for demodulating an oscillation signal generated by said oscillating device and reproducing the data.
